(19) United States
(12) Patent Application Publication
(10) Pub. No.: US 2023/0053142 A1
(43) Pub. Date: Feb. 16, 2023

(54) METHOD AND SYSTEM FOR PLANNING AN OPTIMIZED SOIL CULTIVATION PROCESS

(71) Applicant: CLAAS Tractor SAS, VéIizy-Villacoublay Cedex (FR)

(72) Inventors: Christian Birkmann, Versmold (DE); Jan Carsten Wieckhorst, Uelzen Ortsteil Hanstedt 2 (DE); Jona Pieper, Nordkirchen (DE); Christian Schaub, Paderborn (DE); Christian Ehlert, Bielefeld (DE); Lennart Meyer, Aachen (DE)

(73) Assignee: CLAAS Tractor SAS, VéIizy-Villacoublay Cedex (FR)

(21) Appl. No.: 17/880,904

(22) Filed: Aug. 4, 2022

(30) Foreign Application Priority Data
Aug. 10, 2021 (DE) 102021120812.2

(51) Int. Cl. A01B 79/00; A01B 63/111

(52) U.S. Cl. CPC A01B 79/005; A01B 63/1112

(57) ABSTRACT

A method and system for planning an optimized soil cultivation process of a field for anf agricultural combination is disclosed. The agricultural combination includes an agricultural production machine and a soil cultivating agricultural attachment. A planning control assembly is used to determine recommended actions for the soil cultivation process with an expert model using soil data of the field, wherein the soil data of the field is location-dependent.

### CROSS REFERENCE TO RELATED APPLICATION

This application claims priority under 35 U.S.C. § 119 to German Patent Application No. DE 10 2021 120 812.2 filed Aug. 10, 2021, the entire disclosure of which is hereby incorporated by reference herein. This application is further related to: US Utility Application Serial No. ______ (attorney docket no. 15191-22008A (P05464/8)); US Utility Application Serial No. ______ (attorney docket no. 15191-22009A (P05465/8)); US Utility Application Serial No. ______ (attorney docket no. 15191-22010A (P05466/8)); US Utility Application Serial No. ______ (attorney docket no. 15191-22011A (P05469/8)); US Utility Application Serial No. ______ (attorney docket no. 15191-22013A (P05499/8)), each of which are incorporated by reference herein in their entirety.

### TECHNICAL FIELD

The present invention relates to a method and system for planning an optimized soil cultivation process.

### BACKGROUND

This section is intended to introduce various aspects of the art, which may be associated with exemplary embodiments of the present disclosure. This discussion is believed to assist in providing a framework to facilitate a better understanding of particular aspects of the present disclosure. Accordingly, it should be understood that this section should be read in this light, and not necessarily as admissions of prior art.

Agricultural production machines such as combines, forage harvesters, and tractors may be combined with various attachments. These attachments are attached via an equipment interface to the agricultural production machine. In one instance, an agricultural combination comprises a combination of an agricultural production machine with an agricultural attachment. Further, the agricultural attachment may be pulled by the agricultural production machine.

Such attachments may serve to perform an agricultural job, such as on soil cultivation (e.g., plowing or cultivating). Common to these types of soil cultivation is that the agricultural attachments are generally adjusted to a specific working depth. The success and the energy consumption of the soil cultivation frequently depend largely on the working depth. At the same time, however, it depends on various machine parameters of the agricultural attachment of the agricultural production machine.

### BRIEF DESCRIPTION OF THE DRAWINGS

The present application is further described in the detailed description which follows, in reference to the noted drawings by way of non-limiting examples of exemplary implementation, in which like reference numerals represent similar parts throughout the several views of the drawings, and wherein:

FIG. 1 illustrates an agricultural fleet with the sensor assembly while the disclosed method is being performed, and

FIG. 2 schematically illustrates the measurement and calculation of different working depths of a plow.

### DETAILED DESCRIPTION

As discussed above, the working depth is generally adjusted at the beginning of soil cultivation, such as manually, based on the user's experience and not by using objective criteria. Moreover, the working depth is frequently not readjusted during the soil cultivation process. However, this neglects the fact that the parameters of the agricultural production machine may influence on the working depth. Accordingly, a rear power lifter may, for example, lift a plow or adjust its working depth. These changes may not be obvious to the user or may be frequently made depending on the control parameters such as insufficient traction, and are not harmonized with the soil cultivation process. WO 2019/158454 A1 discloses regulating the working depth; however, it is a relative working depth that is determined using a cylinder length of the plow and not in relation to the ground. Machine parameters of the agricultural production machine are therefore still not considered.

Moreover, a field is rarely homogeneous enough to be able to be optimally cultivated using a single working depth. For example, DE 10 2019 125 896 A1 discloses determining the soil properties. Based on the soil properties, a working depth, such as an optimized working depth, for various parts may, in principle, be calculated. The aforementioned problems remain, however, in controlling or regulating the working depth.

Sensors for determining an absolute working depth are possible but relatively expensive. An agricultural business frequently has various agricultural attachments that would all profit from determining a working height. The working depth is considered a special case of the working height. In one or some embodiments, the working depth is a working height that extends into the ground. For economic reasons, the agricultural attachments may not, however, all be provided with a sensor for determining or sensing the working height. Ultimately, the absolute working depth of soil cultivating attachments is therefore generally not determined in praxis.

Moreover, the planning of soil cultivating processes may be frequently a manual-based activity based on the experience of a farmer. It is therefore a challenge to improve the known prior art with respect to soil cultivation.

Thus, in one or some embodiments, a system and method for improved soil cultivation that brings about an improvement of the aforementioned disadvantages and/or may be used in a cost-efficient manner is disclosed.

One consideration is that recommended actions for a soil cultivation process may be generated using a planning control assembly. These recommended actions may be determined from a model, such as an expert model. By considering soil data of a field that may depend on the location, specific recommended actions may be determined. The soil data may be location-dependent that may change over a field and correspondingly depict data for different positions on the field dependent on the position on the field (e.g., within a single field, the soil data may be different at different locations therein).

In particular, a method for planning a soil cultivation process (such as an optimized soil cultivation process) of a field for an agricultural combination is disclosed. The agricultural combination may include an agricultural production machine and a soil cultivating agricultural attachment. Further, a planning control assembly may be used to determine one or more recommended actions for the soil cultivation process. In particular, the planning control assembly may access soil data and a model, such as an expert model. In turn, the planning control assembly, using soil data of the field, such as is location-dependent soil data, and the model in order to generate the one or more recommended actions. In turn, the one or more recommended actions may be used to perform the soil cultivation process. As one example, the one or more recommended actions may be output, such as via a display, to a user for acceptance or rejection. If accepted by the user, the soil cultivation process may use the one or more recommended actions to perform the soil cultivation process (e.g., combination control assembly (discussed below) may use the accepted one or more recommended actions to perform the soil cultivation process). As another example, responsive to generating the one or more recommended actions, the combination control assembly may automatically implement the one or more recommended actions to perform the soil cultivation process.

In one or some embodiments, the one or more recommended actions may concern which type of soil cultivation is to be performed. The effect that may be achieved by selecting optimized soil cultivation in terms of cost or effectiveness may be significant in comparison to the effect of changing how soil cultivation is performed. This decision may be made through a holistic consideration of the field based on the location-specific soil data. For reasons of efficiency, suboptimum solutions may be considered for individual areas of the field if this, for example, eliminates an entire type of soil cultivation. Thus, the one or more the recommended actions may include a type of soil cultivation, such as a recommendation as to whether the soil cultivation should include a cultivator and/or plow

In one or some embodiments, the configuration of the soil processing may also be disclosed in addition to (or instead of) the type thereof. The combined optimization of the type of soil processing and its configuration may allow for improved optimization of the end result of soil cultivation. It is, for example, contemplated to sometimes replace a cultivator with a more complex plow, or vice versa. Thus, the one or more recommended actions may include a type of soil cultivation and parameters of soil cultivation, such as a working depth.

In one or some embodiments, an individual sensor (such as a single sensor) for determining the working height of various agricultural attachments may be used. This sensor may be attached to a mounting position on the agricultural production machine or the agricultural attachments. Through reuse, an individual sensor does not have to be acquired for each attachment; this makes it possible to support various work processes with fewer sensors needing to be used. In one or some embodiments, the focus is on the use of such a sensor in soil cultivation, wherein the mounting position is calculated from the measured data, or an optimized working depth is determined depending on the mounting position. This may allow for economical optimization of soil cultivation that may also makes it possible to regulate the absolute working depth based on the measured data of the sensor on the field depending on the location in the field. Accordingly, the entire field no longer has to be cultivated with a single working depth that may change uncontrollably. Instead, it is possible to plan and execute soil cultivation in an optimized fashion, considered and accounting for the changes in soil within a single field. As such, the sensor assembly may determine the absolute working depth of the agricultural attachment and may include a sensor for determining, sensing or generating measured data relating to an absolute working depth of the agricultural attachment, a sensor holder, and a sensor control assembly. In practice, when the sensor is in a state of being mounted at a mounting position (within the sensor holder that is more permanently mounted at the mounting position), the sensor records or senses measurement data relating to an absolute working depth of the agricultural attachment during the soil cultivation process and the measurement data is transmitted to the sensor control assembly (e.g., the sensor transmits the measured data or the sensor assembly accessing a memory into which the measurement data is stored). The planning control assembly may then determine an optimized absolute working depth of the agricultural attachment (as the recommended action) for the soil cultivation process using a model, such as expert model, using the soil data for the soil cultivation process. In turn, the combination control assembly may set the determined optimized working depth for the soil cultivation process on the agricultural attachment, with the sensor assembly being configured to determine the working height of different attachments using the same sensor. Further, the sensor control assembly may determine a mounting-position-independent working depth from the measured data and/or the planning control assembly may determine the optimized absolute working depth depending on the mounting position.

In one or some embodiments, a modular sensor system may be used in which the sensor may be reversibly mounted on the agricultural attachments and may thus be used to determine the working height of a plurality of attachments (e.g., the same sensor may be reversibly mounted at different times onto different sensor holders attached to different ones of the plurality of attachments). This has the advantage that the determination of a working height using a sensor on an agricultural attachment may be solved in a technically easy way by determining a distance between the sensor and the ground.

In one or some embodiments, the sensor may be designed as a distance sensor. These have especially proven themselves in the agricultural sector and may provide a good balance between robustness and cost. In particular, the sensor may comprise an especially contact-free distance sensor, such as a distance sensor that functions based on electromagnetic waves, or acoustic waves, or mechanical sensing. In particular, the distance sensor may comprise a radar sensor, a lidar sensor, an optical sensor, or an ultrasonic sensor. Or, the sensor may comprise a force sensor or position sensor, on a component that touches the ground, such as a sensing bracket, a grinding skid or a support roller.

In one or some embodiments, the soil data may be considered by the planning control assembly. In one or some embodiments, the soil data may comprise general soil data, the information on the general condition, such as information of the entire field. More specifically, the soil data may comprise a crop sequence of the field (such as comprising current crops, and/or past crops, and/or intermediate crops, and/or planned crops) and/or environment data (such as climate data (e.g., temperatures and/or precipitation levels) and/or soil type data, and/or soil condition data.

In one or some embodiments, the location-dependent soil data may comprise lane data (such as driving lane data) which may indicate how much soil of the field was compacted in a lane. In particular, the driving lane data may comprise combination data on agricultural combinations used in the driving lanes, such as any one, any combination, or all of: wheel loads; tire dimensions; tire pressures; or a soil condition while driving. It may therefore be considered that the soil condition within the lanes may significantly deviate from the soil condition outside of the lanes.

In one or some embodiments, the location-dependent soil data may include work process data on past soil cultivating processes and/or past crop cultivating processes. In addition to general properties and the like, a field may be characterized by its use and cultivation. Different crop sequences, different soil cultivations and the like may change the field condition and the soil condition. These are, for example, root properties of the crop, fertilization processes and naturally invasive soil cultivation like plowing. In particular, the work process data may comprise data on any one, any combination, or all of: working depths; attachments from past soil cultivation processes; data on fertilizations; plant protection measures; or rains from past field cultivation processes.

In one or some embodiments, in order to be able to adapt the model, such as adapting the mode depending on the specific field, or to consider feedback in general, the work process data may comprise harvest data of past harvest periods. This may be used to approximate unknown influences and properties of the field.

In one or some embodiments, environmental data may also be included in the soil data. This may include a soil type and/or a soil condition and may be determined by laboratory analyses from soil samples. Fertilization processes and the weather may also on the soil condition. As such, the location-dependent soil data may comprise environment data, such as soil type data and/or soil condition data. The soil type data and/or the soil condition data may have at least partially been determined from soil samples and/or nutrient data.

In one or some embodiments, image data and/or satellite data of the field may be used in order, for example, to obtain and consider the biomass data and weed data. In particular, the biomass data may be determined from the satellite data. Further, a drone image of the field may comprise the image data of the field, and may be used of weed data, such as particular weed types in the field.

In one or some embodiments, the planning control assembly may also consider existing or available agricultural combinations, such as available agricultural production machines and available agricultural attachments using the model. In so doing, different agricultural production machines and agricultural attachments have different effects on the soil, may realistically achieve very different working depths and, if applicable, may be provided to several fields simultaneously so that the agricultural machinery is distributed accordingly. As such, in one or some embodiments, the planning control assembly, using the model, may suggest a particular agricultural production machine and/or a particular agricultural attachment to perform the soil cultivation process.

In one or some embodiments, other settings of the agricultural attachment may also be selected, such as optimized, using the model. In one particular example, a cutting width of a plow may be selected. Accordingly, some or all the parameters of soil cultivation may be harmonized with each other. As such, the planning control assembly may determine at least one additional optimized setting of the agricultural attachment using the model, such as the working depth, and may additionally optimize setting of the cutting width of the plow.

In one or some embodiments, the planning control assembly, using the model, proposes a selection of potential sensors (such as an optimized selection of potential sensors) and mounting positions. The more agricultural production machines, agricultural attachments and sensors there are, the more complex their use may potentially be. For example, the sensors may be distributed to the work processes in which deviations of the working height or working depth have the greatest influence in order to achieve an optimized result with limited resources. As such, the planning control assembly, using the model, proposes suggestions (such as an optimized suggestion) of any one, any combination, or all of: one or more sensors; one or more sensor types; one or more mounting positions; or a number of sensors of the sensor arrangement assembly.

In one or some embodiments, at least a part of the sensor assembly, such as the sensor, may be reused. As such, measured values of past soil cultivation processes may be used as soil data. In particular, the soil data may have been at least partially determined in previous soil cultivation processes using the same sensor(s) of the sensor assembly, with the soil data at least partially having been determined in previous soil cultivation processes using the same sensor(s) of the sensor assembly on different attachments.

In one or some embodiments, target specifications on competing goals may be considered by the planning control assembly. For example, soil cultivation may be configured for maximum speed or maximum fuel efficiency. Neither of the two options may necessarily always be the right one per se. If soil cultivation must be finished before the weather changes, the speed may be prioritized. As such, the planning control assembly may consider the target specifications of competing goals when determining the optimized working depth, with the target specifications include any one, any combination, or all of: a minimum fuel consumption; a maximum speed for performing the soil cultivation process; minimization of the cost of the soil cultivation process; or maximization of the work quality.

In one or some embodiments, a planning control assembly configured for use in the disclosed method is claimed. Reference may be made to all statements regarding the disclosed method.

In one or some embodiments, an agricultural production machine may be configured to plan and perform a soil cultivation process of a field. The agricultural production machine may include: an equipment interface configured to attach to a soil cultivating agricultural attachment; one or more control assemblies (e.g., the planning control assembly and/or the combination control assembly) configured to: access an expert model; access soil data of a field, the soil data being location-dependent; and determine, using the expert model, one or more recommended actions for the soil cultivation process from the soil data of the field; and perform the one or more recommended actions for the soil cultivation process.

Referring to the figures, the agricultural production machine 1 comprises a tractor. The agricultural production machine 1 may be equipped via at least one equipment interface 2 with at least one agricultural attachment 3. The equipment interface 2 may generally be a mechanical coupling between the agricultural production machine 1 and the agricultural attachment 3. In the depicted embodiment, the equipment interface 2 is designed as a three point power lifter that has two lower links and one upper link for coupling to the agricultural attachment 3. The equipment interface 2 may be designed as a front or rear power lifter. In principle, the equipment interface 2 may also be a ball hitch. Other versions of the equipment interface 2 are systems with a simple drawbar coupling, with hitch hooks, with a ball head coupling, or the like. In one or some embodiments, the soil cultivating attachments are an independent vehicles.

The embodiment shown describes a method for planning an optimized soil cultivating process of a field for an agricultural combination 4.

The agricultural combination 4 has an agricultural production machine 1 and a soil cultivating agricultural attachment 3. The agricultural attachment 3 may be a plow 5, a cultivator, and the like.

Moreover, in one or some embodiments, a sensor assembly 6, explained further below, is configured to determine an absolute working depth 7 of the agricultural attachment 3. The sensor assembly 6 has a sensor 8 for determining measured data relating to an absolute working depth 7 of the agricultural attachment 3, a sensor holder 9, and a sensor control assembly 10. When the sensor is in a state mounted at a mounting position 11, the sensor 8 records measurement data relating to an absolute working depth 7 of the agricultural attachment 3 during the soil cultivation process and at least a part of the measurement data is transmitted to the sensor control assembly 10 (e.g., the sensor 8 transmits the measurement data or the sensor control assembly 10 accesses a memory storing the measurement data).

The sensor assembly 6 as such may be integrated independently at least partially in the agricultural production machine 1. In particular, the sensor control assembly 10 of the sensor assembly 6 may, for example, be a control assembly of the agricultural production machine 1. Likewise, this may, however, also comprise (or consist of) distributed computing units. It may for example have a control unit of the agricultural production machine 1 and a cloud control unit.

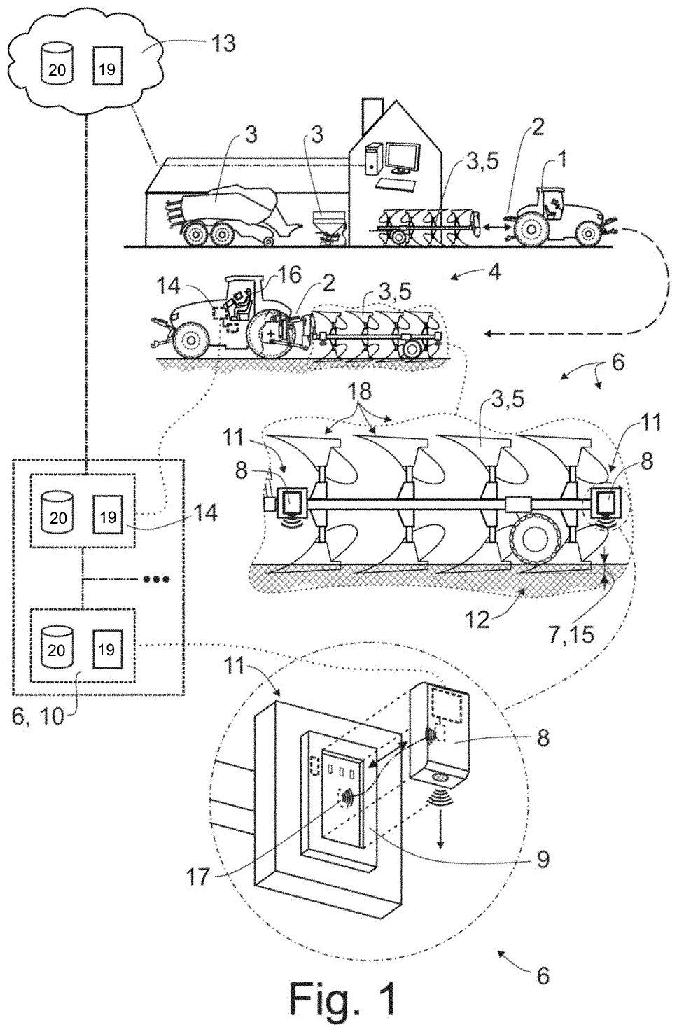

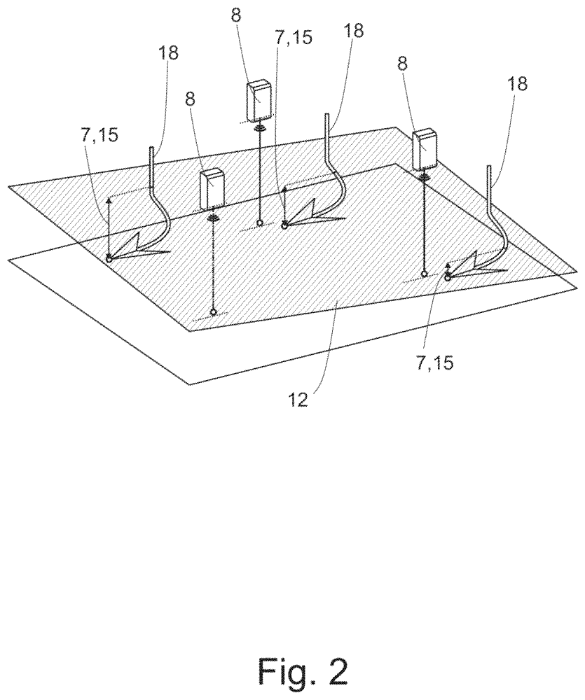

Thus, the various assemblies, such as the sensor control assembly 10, the planning control assembly 13, and/or the combination control assembly 14, or any other functionality described herein may use computing logic and may comprise any type of computing functionality, such as at least one processor 19 (which may comprise a microprocessor, controller, PLA, or the like) and at least one memory 20. This is illustrated, for example, in FIG. 1, with the computing functionality equally applied to FIG. 2. The memory 20 may comprise any type of storage device (e.g., any type of memory). Though the processor 19 and memory 20 are depicted as separate elements, they may be part of a single machine, which includes a microprocessor (or other type of controller) and a memory. Alternatively, processor 19 may rely on memory 20 for all of its memory needs.

The processor 19 and memory 20 are merely one example of a controller assembly configuration. Other types of controller assembly configurations are contemplated. For example, all or parts of the implementations may be circuitry that includes a type of controller, including an instruction processor, such as a Central Processing Unit (CPU), microcontroller, or a microprocessor; or as an Application Specific Integrated Circuit (ASIC), Programmable Logic Device (PLD), or Field Programmable Gate Array (FPGA); or as circuitry that includes discrete logic or other circuit components, including analog circuit components, digital circuit components or both; or any combination thereof. The circuitry may include discrete interconnected hardware components or may be combined on a single integrated circuit die, distributed among multiple integrated circuit dies, or implemented in a Multiple Chip Module (MCM) of multiple integrated circuit dies in a common package, as examples.

Using the sensor 8, an absolute working depth 7 is measured. In one or some embodiments, the term “absolute” is not necessarily to be understood as a precise measurement, but generally as a measurement relative to the ground 12. In one or some embodiments, the measurement may be relative to a component whose height or depth relative to the ground 12 is known. In one or some embodiments, however, the absolute working depth 7 may be measured directly relative to the ground 12.

In one or some embodiments, a planning control assembly 13 is provided and may use a model, such as an expert model, to determine one or more recommended actions for the soil cultivation process from soil data of the field.

In one or some embodiments, the soil data of the field may be location-dependent. In one or some embodiments, the term “location-dependent” may be understood to mean that the soil data changes over a respective field and correspondingly has a local resolution on the respective individual field. The use of location-dependent soil data to determine recommended actions for soil cultivation enables recommended actions that are optimized for the respective field as a whole.

In one or some embodiments, the recommended change may be output (such as via a display resident in the agricultural production machine 1) to a user who may accept it, reject it, or modify it depending on his/her experience. In one or some embodiments, the final decision therefore may rest with the user. Alternatively, the one or more recommended actions may be automatically implemented without input from the user.

The one or more recommended actions may include a type of soil cultivation, such as a recommendation as to whether the soil cultivation should include a cultivator and/or plow. Normally, the decision on the type of soil cultivation may be made based on experience and or the user's habit. Optimizing this decision using the planning control assembly 13, and therefore based on objective criteria that are saved in the model, may lead to a potential optimization that may generate clear cost savings, such as by omitting individual types of soil cultivation.

In one or some embodiments, the recommended actions may include a type of soil cultivation and/or parameters of soil cultivation, such as a working depth 7. By considering the parameters of soil cultivation, it is in particular possible to perform a more elaborate single soil cultivation instead of two soil cultivations, and/or to plan and thus consider the exact possibilities of these soil cultivations depending on the location when determining the recommended actions.

In one or some embodiments, the planning control assembly 13 determines an optimized absolute working depth 7 of the agricultural attachment 3 for the soil cultivation process using the model, such as expert model, comprising (or consisting of) the soil data. A combination control assembly 14 may set the determined optimized working depth 7 for the soil cultivation process on the agricultural attachment 3.

In one or some embodiments, the combination control assembly 14 and the sensor control assembly 10 may overlap each other partially or be identical. As such, the processor 19 and the memory 20 may be common to both the combination control assembly 14 and the sensor control assembly 10.

In one or some embodiments, the sensor assembly 6 is configured to determine the working height 15 of different attachments using the same sensor 8, the sensor control assembly 10 determines a mounting-position-independent working depth 7 from the measured data, and/or the planning control assembly 13 determines the optimized absolute working depth 7 depending on the mounting position.

In one or some embodiments, the mounting position 11 may be arranged on the agricultural attachment 3 or the agricultural production machine 1. Further, the mounting position 11 may be fixed or variable. In one or some embodiments, the mounting position 11 is adapted to the work process as will be explained in the context of the modular sensor system. Likewise, the sensor 8 may, however, also be fixedly connected to the agricultural production machine 1 (e.g., connected to the sensor holder 9).

In one or some embodiments, the model comprises an expert model that, if applicable, may be expanded with field-specific feedback. Other types of models are, however, contemplated. In particular, it is contemplated to train an AI model from the aforementioned soil data and yield data.

In one or some embodiments, setting the working depth 7 using the combination control assembly 14 need not be comprehensive. It may moreover be provided that some machine parameters that help determine the working depth 7 may be manually adjusted by user 16. It may then be provided that the user 16 enters the set machine parameters into the combination control assembly 14, or the combination control assembly 14 determines these machine parameters in a different way.

In one or some embodiments, the sensor assembly 6 may therefore be used not just for one soil cultivating attachment that comprises the agricultural attachment 3 but may also be used for a plurality of different agricultural attachment 3. Further, the sensor assemblies 6 need not all be soil cultivating. Correspondingly, the sensor 8 may generally serve to determine a working height 15 that may also be negative (e.g., less than zero) in the case of the working depth 7.

In one or some embodiments, the mounting position 11 is on the soil cultivating attachment that comprises the agricultural attachment 3. FIG. 2 schematically shows, for example, how there may be a longitudinal angle and a transverse angle of a soil cultivating attachment that ensure that the working depth 7 per se is not constant over the plow 5. FIG. 2 moreover shows how a plurality of sensors 8 may be used in order to determine these angles or a plurality of working depths 7 in general.

Moreover, in one or some embodiments, the sensor 8 may be reversibly mounted on the agricultural attachments 3, the sensor 8 may be used to determine the working height 15 of a plurality of agricultural attachments 3 and may always be mounted on the agricultural attachment 3 to do this, with the sensor 8 being reversibly mounted at a mounting position 11 on different agricultural attachment 3 using the at least one sensor holder 9 (e.g., different sensor holders 9 are connected to the different agricultural attachment 3; the sensor 8 is reversibly connected to different sensor holders 9 on the different attachments to perform the measurements). As such, respective sensor holders 9 may be mounted separate from the sensor 8 on the different agricultural attachment 3, and the sensor 8 may be reversibly mounted in a respective sensor holder 9.

Moreover, in one or some embodiments, the sensor 8 is an especially contact-free distance sensor. The distance sensor may function based on electromagnetic waves, or acoustic waves, or mechanical sensing. Further, the distance sensor may comprise a radar sensor, or a lidar sensor, or an optical sensor, or an ultrasonic sensor. Or, the sensor 8 may comprise a force sensor or position sensor, on a component touching the ground 12, such as a sensing bracket, a grinding skid or a support roller.

In one or some embodiments, the sensor control assembly 10 and/or the combination control assembly 14 determines the working height 15 of the particular agricultural attachment 3 from a mounting-position-specific calibration data set. Overall, some or all of the functions described with respect to the sensor assembly 10 may also be adopted by the combination control assembly 14, or both may be formed by a common control assembly.

In one or some embodiments, the sensor 8 is reversibly mounted using the sensor holder 9 at the mounting position 11 such that the mounting is nondestructively reversible. In particular, the sensor holder 9 may be installed upon manufacture of the agricultural attachment 3. Alternatively, installing the sensor holder 9 may be performed on site in the field using simple tools, or entirely without tools.

In one or some embodiments, the mounting-position-specific calibration data set, as will be explained, may be saved in any desired memory, created new, or provided to the sensor control assembly 10 in a different way.

One advantageous use of the modular sensor system relates to the measurement of the working height 15 of an agricultural attachment 3 that does not have its own electronics. As will be seen below, the sensor assembly 6 may be independent from the agricultural attachment 3. Alternatively, the sensor 8 may not communicate with the agricultural attachment 3. Still alternatively, the sensor 8 is integrated in electronics of the agricultural attachment 3 or communicates therewith. Also in the case of agricultural attachments 3 with electronics, it may however be provided that the sensor 8 does not communicate directly with the agricultural attachment 3. In one or some embodiments, the sensor assembly 6 may be used with agricultural attachments 3 with or without electronics. Alternatively, the determination of the working height 15, apart from the calibration itself, may be completely independent of the agricultural attachment 3.

In one or some embodiments, the situation is such that the mounting-position-specific calibration data sets comprise a reference height, and/or an orientation of the sensor 8 in the mounted state at the particular mounting position 11, and/or a location of the mounting position 11 relative to the agricultural attachment 3.

In one or some embodiments, the reference height may originate from a calibration routine yet to be explained, and may relate to a height of the mounting position 11 of the sensor 8 in a reference state, with a known working height 15. The orientation of the sensor 8 may for example be a tilt of the sensor 8. This may take into account that the sensor 8 might not measure the shortest distance to the ground 12. The location of the mounting position 11 relative to the agricultural attachment 3 may be selected from a group of given mounting positions 11 or be determined in another way. FIG. 1, for example, shows two mounting positions 11 on a plow 5. As will be explained, it is also possible to measure several working heights 15 per agricultural attachment 3 and thereby record, for example, an angle of the agricultural attachment 3. To accomplish this, the mounting position 11 of one or more sensors 8 may be located (e.g., the location of the sensor holder 9, in which the sensor may connect, may be located). Reference is made in this regard to FIG. 2.

In one or some embodiments, the mounting-position-specific calibration data sets are saved in a memory of the sensor control assembly 10. In this case, this memory may comprise a local memory of the agricultural production machine 1. In principle, a cloud memory or the like is also contemplated. Calibration data sets relating to mounting positions 11 of at least two, such as at least three, different types of agricultural attachments 3 may be saved in the memory. The mounting-position-specific calibration data set may be used to determine the mounting-position-independent working depth 7 from the measured data, and/or to determine a mounting-position-dependent working depth 7 from an optimized mounting-position-independent working depth 7.

In one or some embodiments, the agricultural attachments 3 for which a working height 15 is determined using the sensor 8 may comprise different types of agricultural attachments 3. The different types of agricultural attachments 3 may comprise at least one type of soil cultivation device, such as at least two types of soil cultivation devices. The types of soil cultivation devices may comprise a plow 5, and/or a cultivator, and/or a harrow. Alternatively, or in addition, he different types of agricultural attachments 3 may further comprise a fertilizer spreader and/or a seeder, such as a sowing coulter, and/or a mower, and/or a pickup, and/or an agricultural attachment 3 with a pickup, such as a baler or a loader wagon.

As shown in the lower region of FIG. 1, the sensor holder 9 may be mounted separately from the sensor 8 on the different agricultural attachment 3. The sensor 8 may then be reversibly mountable on the sensor holder 9. In one or some embodiments, the sensor holder 9 is a relatively inexpensive mass-produced component, while the sensor 8 itself is relatively expensive. The disclosed method allows the expensive sensor 8 to be reused (e.g., the same sensor 8 may be placed at different times in different sensor holders 9).

For reasons of convenience, the sensor holder 9 may remain on and permanently affixed to the agricultural attachment 3. On the one hand, this has clear advantages in the context of the calibration routine yet be explained, but on the other hand it also enables the sensor holder 9 to be mounted in a stable and more reliable manner, while the mounting of the sensor 8 on the sensor holder 9 itself may be relatively simple. This also allows the same mounting position 11 to be reused when the sensor 8 is attached again. Accordingly, the mounting-position-specific calibration data set may also be assigned to the sensor holder 9 at the corresponding mounting position 11. In order to depict this assignment, the sensor holder 9 may have an identification feature 17. In particular, the identification feature 17 may uniquely identify the respective sensor holder 9 amongst a plurality of sensor holders 9 used across the different agricultural attachments 3.

In one or some embodiments, the identification feature 17 may be transmitted from the sensor holder 9 to the sensor control assembly 10. However, in some embodiments, this sensor holder 9 does not have its own electronics. In particular, it may therefore also be provided that the sensor 8, such as in the mounted state, reads out the identification feature 17 and transmits it to the sensor control assembly 10. In one or some embodiments, the sensor holder 9 has a near field communication (NFC) tag. The sensor 8 may then have an NFC reader, through which the sensor 8 reads out the identification feature 17 of the sensor holder 9 and transmits it to the sensor control assembly 10. Alternatively, the user 16 may enter the identification feature 17 via an input device, such as a smartphone, or read it out with the smartphone. The input device may then communicate with the sensor control assembly 10, or is part of the sensor control assembly 10, to convey the identification feature 17. In one or some embodiments, the identification feature 17 may comprise a QR code that the user 16 reads out, for example in a dedicated app. All these possibilities allow the sensor 8 to be quickly mounted, which may lead directly to the ability of the sensor 8 to determine the working height 15. Instead of a smartphone, a tablet, a laptop, a smartwatch or the like may also be used.

Additionally or alternatively, the user 16 may select the mounting-position-specific calibration data set from an input unit, such as an input unit (e.g., a touchscreen display) of an agricultural production machine 1 that communicates with the sensor control assembly 10, or the sensor control assembly 10 automatically selects the mounting-position-specific calibration data set based on the identification feature 17.

In one or some embodiments, the sensor control assembly 10 performs a calibration routine in which the sensor control assembly 10 generates a mounting-position-specific calibration data set and may save it in the memory. This calibration routine is explained in greater detail below. In one or some embodiments, in the calibration routine, the sensor control assembly 10 saves a reference height and/or an orientation of the sensor 8 in the mounted state at the particular mounting position 11, and/or a location of the mounting position 11 relative to the agricultural attachment 3 in the mounting-position-specific calibration data set.

In one or some embodiments, the calibration routine is performed on level ground. In so doing, the sensor control assembly 10 may inform the user 16 that he should park the agricultural production machine 1 and/or the agricultural attachment 3 on level ground, and/or assume that this has been done. Moreover, in one or some embodiments, the agricultural attachment 3 assumes a reference height. In the case of a plow 5, the reference height may, for example, be established at a working height 15 of zero when the plowshares 18 are placed on the ground 12. However, in a seeder, for example, the lowest adjustable height and a usual working height 15 may be too far apart to calibrate the sensor 8 in this manner and may still remain within the specification of the sensor 8 during use. Therefore, it may equally be provided that the user 16 will enter or otherwise determine the reference height.

In one or some embodiments, the sensor control assembly 10 uses the sensor 8 in the calibration routine to measure a distance of the sensor 8 from the ground 12 and stores this as the reference height. In one or some embodiments, the mounting position 11, which may be specified by the sensor control assembly 10, does not have to be precisely maintained by the user 16, especially in the height direction, since it is removed from the reference height when the working height 15 is determined. In other directions as well, great precision may usually not be important or required due to the tolerances prevailing in agriculture.

In one or some embodiments, if the agricultural attachment 3 has its own setting options for the working height 15, the settings present during the calibration routine may also be saved in the mounting-position-specific calibration data record, and changes to these settings may lead to the user 16 being warned, or are taken into account using the optimization data set when determining the working height 15.

Moreover, in one or some embodiments, the sensor control assembly 10 directs a user 16 through the calibration routine using an output unit (e.g., a display on the agricultural production machine 1) in a natural language dialog, such as the sensor control assembly 10 specifying a mounting position 11 to the user 16, or the user 16 transmitting the mounting position 11, such as by voice entry, to the sensor control assembly 10. In addition or alternatively, the sensor control assembly 10 tells the user 16 a setting of a working height 15 of the agricultural attachment 3, or the user 16 transmits the setting of a working height 15, such as by voice entry, to the sensor control assembly 10, and/or the sensor control assembly 10 tells the user 16 to place the agricultural production machine 1 and/or the agricultural attachment 3 on flat ground.

In one or some embodiments, the dialog may be performed using a voice output device and/or voice input device of the agricultural production machine 1 and/or a smartphone. However, it is equally possible to use a terminal of the agricultural production machine 1 and/or the smartphone without voice input and/or output.

In one or some embodiments, the agricultural production machine 1 and/or the agricultural attachment 3 is on level ground during the calibration routine, the user 16 mounts the sensor holder 9 at a mounting position 11 on an agricultural attachment 3 and connects the sensor 8 to the sensor holder 9, and the sensor control assembly 10 performs a calibration routine in which the sensor control assembly 10 determines a reference height and generates a mounting-position-specific calibration data set and may save it in the memory.

In one or some embodiments, the output unit may be the terminal or the smartphone, and/or may have the voice output device.

In one or some embodiments, the sensor 8 is mountable on the sensor holder 9 in a form fit and/or force fit, such that the sensor 8 is mountable on the sensor holder 9 using a quick-locking device, and/or using one or more screws, and/or magnetically, and/or is clipable in the sensor holder 9. In one or some embodiments, the sensor 8 may be mounted on the sensor holder 9 using commercially available tools or without any tools at all.

In one or some embodiments, the sensor holder 9 has a battery and/or an electrical connection unit, such as a cable or an antenna, for connection to the control assembly, and/or for transmitting energy from an agricultural production machine 1 to the sensor 8, such that the electrical connection unit has a bus connection, such as an ISOBUS or CAN bus connection.

Using a sensor holder 9 with such a design, the sensor 8 may be supplied with energy. At the same time or alternatively, the sensor holder 9 may be used to transmit the data from the sensor 8 to the sensor control assembly 10. In one or some embodiments, the sensor control assembly 10 may be part of the agricultural production machine 1, or the connection to the sensor control assembly 10 may run via the agricultural production machine 1. If the sensor holder 9 has a cable that may be connected to a bus of the agricultural production machine 1 if necessary, and if the sensor holder 9 remains on the agricultural attachment 3, the wiring only has to be done once. This is a logical extension of the “plug and play” concept of the sensor assembly 6. The battery may of course alternatively be rechargeable. In the same way, the sensor 8 may also have its own battery or may be rechargeable. In particular, in one or some embodiments, the sensor holder 9 has no electronics at all, in which case the NFC tag does not count as electronics (e.g., the NFC tag is merely passive). Provided that the agricultural attachment 3 has its own power supply, which may be powered by the agricultural production machine 1, the sensor 8 may also be connected thereto, such as via the sensor holder 9 (e.g., a connector on the sensor holder may provide both power and communication pins; installing or inserting the sensor 8 into the sensor holder 9 may connect the sensor 8 to the power and communication pins, thereby providing power to the sensor 8 and communication capability with other control assembly(ies), such as the sensor control assembly 10).

As previously noted, various agricultural attachments 3 may have different relevant working heights 15. For example, a plow 5 with several plowshares 18 is shown in FIG. 1. Each of these plowshares 18 has its own working height 15. If the plow 5 is for example strongly angled along its longitudinal axis, optimization of only one working height 15 would not yield optimal results.

In one or some embodiments, the sensor control assembly 10 may additionally determine the working height 15 from an agricultural attachment-specific calibration data set, and the agricultural attachment-specific calibration data set comprises kinematics of the particular agricultural attachment 3, and/or the sensor control assembly 10 may additionally determine the working height 15 from a coupling data set, with the coupling data set comprising machine parameters of an equipment interface 2 between the agricultural production machine 1 and the particular agricultural attachment 3, with the coupling data set comprising machine parameters of a three-point power lifter.

Using the agricultural attachment-specific calibration data set and coupling data set, the number of necessary sensors 8 to determine several working heights 15 may be reduced, for example, via an axis transformation using the kinematics of the agricultural attachment 3 or via known machine parameters of the equipment interface 2. The determination of a single working height 15 may also be verified or performed more precisely in this way, if necessary. In one or some embodiments, however, at least one working height 15 may be determined without considering the machine parameters of the equipment interface 2. FIG. 2 shows how a plurality of working depths 7 may be determined using a plurality of sensors 8 from which the working depth 7 of the plowshares 18 may then be determined.

In principle, the agricultural attachment-specific calibration data set may be contained in the mounting-position-specific calibration data set, or vice versa. The coupling data set may be attachment-specific, but does not have to be. It may comprise, for example, lengths of hydraulic cylinders of the equipment interface 2. Generally speaking, machine parameters are to be understood as some or all of the settings, associated sensor measured values, and the like. In this case, the machine parameters relate at least partially to machine parameters that have a direct influence on the working height 15 that is to be detected.

Moreover, in one or some embodiments, the soil data comprise a crop sequence of the field, such as comprising current crops, and/or past crops, and/or intermediate crops, and/or planned crops, and/or environment data, such as climate data, such as temperatures and/or precipitation levels, and/or soil type data, and/or soil condition data.

These data may originate from a database, from the Internet, and/or from the agricultural combination 4. They may have in common that they generally relate to the entire field. In addition to these general data, soil data may also be provided that very specifically only relate to certain field sections (e.g., subparts of the field) and the like. These are described in greater detail below.

In this case, the situation is such that the location-dependent soil data comprise driving lane data. In one or some embodiments, the driving lane data may comprise combination data on agricultural combinations 4 used in the driving lanes, such as wheel loads, and/or tire dimensions, and/or tire pressures, and/or a soil condition while driving. The compaction of the driving lanes may then be inferred from the combination data.

In one or some embodiments, the soil condition while driving may have been determined in a previous plan using the model. It may be preferable for the soil condition to be determined from data from previous uses of the disclosed method.

In one or some embodiments, the location-dependent soil data comprise work process data on past soil cultivating processes and/or past crop cultivating processes. In one or some embodiments, the work process data comprise data on working depths 7 and/or agricultural attachments 3 from past soil cultivation processes, and/or data on fertilizations, and/or plant protection measures, and/or rains from past field cultivation processes.

In one or some embodiments, a current soil condition is determined from the past soil condition in combination with a series of soil cultivation processes.

Moreover, in this case, the work process data may comprise harvesting data from past harvesting periods, with the model being adapted based on harvesting data from past working processes, such as depending on the field.

In one or some embodiments, the model itself is not adapted to an individual field in a basic state, but it may be adapted using feedback, such as from the aforementioned harvesting data. In this case, the adaptation of the model may be performed automatically. For example, certain situations may be such that it is scarcely possible to determine all relevant soil properties and influential parameters. In this case, these deviations may be considered using a correction factor that is determined from harvesting data from past work processes. As such, the correction factor may be used in order to better fit the model to the current use. Alternatively, or in addition, the model may be updated as more data is received.

In one or some embodiments, the location-dependent soil data comprise environment data, such as the environment data comprising soil type data and/or soil condition data, more specifically the soil type data and/or the soil condition data have at least partially been determined from soil samples and/or nutrient data.

Moreover, in one or some embodiments, the location-dependent soil data comprise satellite data of the field, such as from biomass data determined from satellite data, and/or the location-dependent soil data comprise image data of the field, such as drone image data of the field, with the image data of the field comprising weed data, such as weed types.

In one or some embodiments, the planning control assembly 13 may consider existing agricultural production machines 1 and/or agricultural attachments 3 by using the model when determining the optimized working depth 7, which the planning control assembly 13 may suggest a specific agricultural production machine 1 (e.g., one of the existing agricultural production machines 1 that are available) and/or a specific agricultural attachment 3 (e.g., one of the existing agricultural attachments 3 that are available) to perform the soil cultivation process by using the model.

In one or some embodiments, agricultural businesses frequently have a fleet of agricultural production machines 1 and agricultural attachments 3. It is then routinely necessary to not only plan a field cultivation process, but to plan a plurality of work processes simultaneously. The available resources may be distributed to these work processes. There may be some work processes that depend more strongly on the working height 15 or working depth 7. In addition, not every working height 15 may be efficiently adjusted on each agricultural attachment 3 or with each agricultural production machine 1. It may therefore be advantageous to consider these factors when planning in order to plan the soil cultivation process so that the working depth 7 is feasible and also optimized with respect to other work processes. To accomplish this, in one or some embodiments, the planning control assembly 13 may also suggest the specific agricultural production machine 1 and/or the specific agricultural attachment 3 in addition to the working depth 7.

Moreover, in one or some embodiments, the planning control assembly 13 determines at least one additional optimized setting of the agricultural attachment 3 using the model, such as depending on the working depth 7, with the additionally optimized setting being a cutting width of a plow 5.

In one or some embodiments, a soil cultivation process, such as using a plow 5, may be influenced not just by the working depth 7 but also by other machine parameters of the agricultural attachment 3 such as a cutting width of a plow 5.

In addition or alternatively, the planning control assembly 13 may propose a selection (such as an optimized selection) of one or more sensors 8, and/or sensor types, and/or mounting positions 11, and/or a number of sensors of the sensor assembly 6 using the model.

In one or some embodiments, different types of sensors 8 as mentioned above may be used. In principle, as shown in FIG. 2, a plurality of sensors 8 per agricultural attachment 3 may also be used at different mounting positions 11. In terms of overall optimization, such as of a plurality of working processes as well, the sensor placement, number, and type may also be correspondingly optimized.

Moreover, in one or some embodiments, the soil data has at least partially been determined in previous soil cultivation processes using the same sensors 8 of the sensor assembly 6, with the soil data having at least partially been determined in previous soil cultivation processes using the same sensors 8 of the sensor assembly 6 on different agricultural attachment 3.

If the sensors 8 are used over several periods, such as on different agricultural attachment 3, the sensor data from these different working processes may serve as a basis for the model. In this case, the measured data may be saved and processed in a standardized fashion independent of the agricultural attachment and/or independent of the mounting position. Accordingly, a type of soil memory may be generated using the sensor assembly 6.

It is also contemplated for the planning control assembly 13 to consider the target specifications of competing goals when determining the optimized working depth 7, with the target specifications including a minimum fuel consumption, and/or maximum speed for performing the soil cultivation process, and/or minimization of the cost of the soil cultivation process, and/or maximization of the work quality.

Different target specifications may result from the fact that competing goals may be prevalent in agriculture. The maximum speed is, for example, at the cost of fuel efficiency. Depending on the context, one goal or the other goal may be preferred. In this case, the user 16 may weigh the target specifications and may visually set this weighting. This weighting may be entered and considered both when planning the soil cultivation process as well as while performing it. In such a case, planning predominates, however. In addition according to another embodiment, a planning control assembly 13 configured for use in the disclosed method is disclosed. Reference may be made to all statements regarding the disclosed method.

Further, it is intended that the foregoing detailed description be understood as an illustration of selected forms that the invention may take and not as a definition of the invention. It is only the following claims, including all equivalents, that are intended to define the scope of the claimed invention. Further, it should be noted that any aspect of any of the preferred embodiments described herein may be used alone or in combination with one another. Finally, persons skilled in the art will readily recognize that in preferred implementation, some, or all of the steps in the disclosed method are performed using a computer so that the methodology is computer implemented. In such cases, the resulting physical properties model may be downloaded or saved to computer storage.

### LIST OF REFERENCE NUMBERS

1 Agricultural production machine
2 Equipment interface
3 Agricultural attachment
4 Agricultural combination
5 Plow
6 Sensor assembly
7 Working depth
8 Sensor
9 Sensor holder
10 Sensor control assembly
11 Mounting position
12 Floor
13 Planning control assembly
14 Combination control assembly
15 Working height
16 User
17 Identification feature
18 Plowshare
19 Processor
20 Memory

1. A method for planning and performing a soil cultivation process of a field using an agricultural combination, wherein the agricultural combination comprises an agricultural production machine and a soil cultivating agricultural attachment, the method comprising:
accessing an expert model;
accessing soil data of a field, the soil data being location-dependent;
determining, using a planning control assembly and the expert model, one or more recommended actions for the soil cultivation process from the soil data of the field; and
performing the one or more recommended actions for the soil cultivation process.

2. The method of claim 1, wherein the one or more recommended actions comprise a recommendation as to whether the soil cultivation process should include one or both of a cultivator or plow.

3. The method of claim 1, wherein the one or more recommended actions include:
a type of soil cultivation; and
one or more parameters of soil cultivation including a working depth.

4. The method of claim 1, further comprising determining, using a sensor assembly, an absolute working depth of the agricultural attachment;
wherein the sensor assembly includes a sensor for sensing measured data relating to the absolute working depth of the agricultural attachment, a sensor holder mounted at a mounting position, and a sensor control assembly;
when the sensor is in a state being mounted at a mounting position of the sensor holder, the sensor records measurement data during the soil cultivation process relating to the absolute working depth of the agricultural attachment;
wherein at least a part of the measured data is transmitted to the sensor control assembly;
wherein the planning control assembly determines, based on the soil data, an optimized absolute working depth of the agricultural attachment for the soil cultivation process;
wherein, responsive to the planning control assembly determining the optimized absolute working depth, a combination control assembly sets the determined optimized absolute working depth for the soil cultivation process on the agricultural attachment;
wherein the sensor assembly is configured to determine a working height of different agricultural attachments using a same sensor; and
wherein one or both of:
the sensor control assembly determines a mounting-position-independent working depth from the measured data; or
the planning control assembly determines the optimized absolute working depth depending on the mounting position.

5. The method of claim 4, wherein the sensor is reversibly mounted in respective sensor holders at a respective mounting position on a plurality of agricultural attachments; and
wherein the sensor, being mounted on a respective agricultural attachment via the respective sensor holders, is used to determine the working height of respective ones of the plurality of agricultural attachments.

6. The method of claim 5, wherein the sensor comprises a contact-free distance sensor that functions based on at least one of electromagnetic waves, or acoustic waves, or mechanical sensing; and
wherein the distance sensor comprises:
a radar sensor, a lidar sensor, an optical sensor, or an ultrasonic sensor; or
a force sensor or position sensor, on a component touching ground in which the component comprises at least one a sensing bracket, a grinding skid or a support roller.

7. The method of claim 4, wherein the planning control assembly determines, based on a working depth using the expert model, at least one additional optimized setting of the agricultural attachment; and
wherein the at least one additional optimized setting comprises a cutting width of a plow.

8. The method of claim 4, wherein the planning control assembly proposes, using the expert model, one or more optimized suggestions for one or more of: one or more sensors; one or more sensor types; one or more mounting positions; or a number of sensors of the sensor assembly.

9. The method of claim 4, wherein the soil data has at least partially been determined in previous soil cultivation processes using a same one or more sensors of the sensor assembly; and
wherein the soil data has at least partially been determined in previous soil cultivation processes using same at least one sensor of the sensor assembly on different attachments.

10. The method of claim 4, wherein the planning control assembly considers target specifications of competing goals when determining the optimized working depth; and
wherein the target specifications include one or more of: a minimum fuel consumption; maximum speed for performing the soil cultivation process; minimization of cost of the soil cultivation process; or maximization of work quality.

11. The method according of claim 1, wherein the soil data comprise one or more of: a crop sequence of the field; environment data; soil type data; or soil condition data.

12. The method of claim 11, wherein the crop sequence of the field comprises one or more of current crops; past crops; intermediate crops; or planned crops; and
wherein the environment data comprises climate data including one or more of temperatures or precipitation levels.

13. The method of claim 1, wherein the location-dependent soil data includes driving lane data;
wherein the driving lane data comprises combination data on combinations used in driving lanes including one or more of: wheel loads; tire dimensions; tire pressures; or soil condition while driving.

14. The method of claim 1, wherein the location-dependent soil data comprise one or more of: work process data on one or both of past soil cultivating processes or past crop cultivating processes; and
wherein the work process data comprise data on:
one or both of working depths or the agricultural attachments from the past soil cultivation processes;
data on fertilizations;
plant protection measures;
or rains from past field cultivation processes.

15. The method of claim 14, wherein the work process data comprise harvesting data from past harvesting periods; and
wherein the expert model is adapted based on the harvesting data that depends on a field from the past harvesting periods.

16. The method of claim 1, wherein the location-dependent soil data comprise environment data;
wherein the environment data comprise one or both of: soil type data; soil condition data including the soil type data; and
wherein the soil condition data has at least partially been determined from one or both of soil samples or nutrient data.

17. The method of claim 1, wherein the location-dependent soil data comprise one or both of:
satellite data of the field including from biomass data determined from satellite data; or
image data of the field including drone image data of the field and comprising weed data including weed types.

18. The method of claim 1, wherein a plurality of existing agricultural production machines are available for performing the soil cultivation process;
wherein the planning control assembly considers one or both of the plurality of existing agricultural production machines or the agricultural attachments by using the expert model when determining an optimized working depth; and
wherein, based on the planning control assembly considering one or both of the plurality of existing agricultural production machines or the agricultural attachments by using the expert model when determining an optimized working depth, the planning control assembly suggests one or both of a specific agricultural production machine or a specific agricultural attachment to perform the soil cultivation process by using the expert model.

19. An agricultural production machine configured to plan and perform a soil cultivation process of a field, the agricultural production machine comprising:
an equipment interface configured to attach to a soil cultivating agricultural attachment;
one or more control assemblies configured to:
access an expert model;
access soil data of a field, the soil data being location-dependent; and
determine, using the expert model, one or more recommended actions for the soil cultivation process from the soil data of the field; and
perform the one or more recommended actions for the soil cultivation process.

20. The agricultural production machine of claim 19, wherein the one or more recommended actions comprise a recommendation as to whether the soil cultivation process should include one or both of a cultivator or plow.
